(19) United States
(12) Patent Application Publication
(10) Pub. No.: US 2012/0055460 A1
(43) Pub. Date: Mar. 8, 2012

(54) Internally Adjustable Damper

(75) Inventor: Jeffrey S. Lambertson, Danville, CA (US)

(73) Assignee: Streivor Air Systems, Inc., Hayward, CA (US)

(21) Appl. No.: 12/875,086

(22) Filed: Sep. 2, 2010

(51) Int. Cl. F24C 15/20; G05D 7/03; F24F 13/10

(52) U.S. Cl. 126/299 D; 454/347; 137/1

(57) ABSTRACT

An internally adjustable damper for use in a commercial kitchen includes a housing having a sidewall defining an interior, a first open end, and a second open end in fluid communication with the first open end. A damper blade is disposed within the housing and is rotatable about an axis of rotation to allow a selectable air flow resistance. An arch extends from the damper blade and adjacent to the sidewall, the arch being symmetric about the axis of rotation. A threaded stud extends from the sidewall into the interior of the housing and is disposed adjacent the arch. A fastener is operatively coupled to the threaded stud, wherein the fastener is adapted to selectively press down against the arch, thereby fixing the location of the damper blade, and retract from the arch, thereby allowing the damper blade to rotate about the axis of rotation. The fastener and the baffle are accessible from inside the housing through either the first open end or the second open end.

### BACKGROUND OF THE INVENTION

The present invention relates generally to exhaust hoods and, more particularly, to a internally adjustable damper device for use with exhaust hoods in commercial kitchens for varying the resistance that an exhaust fan has to overcome thereby controlling the volume of air being exhausted through the hood.

FIG. 1 shows a known kitchen ventilation system (KVS). Cooking equipment such as a stove 10 creates heat, smoke, volatile organic compounds, grease particles, vapor, and other effluents 12 during cooking A kitchen ventilation system 14 is used to capture, contain and exhaust these effluents 12 to avoid health and fire hazards. The typical KVS 14 includes a hood 16, an exhaust plenum 18 with a filter 20 disposed within the hood 16, an exhaust duct 22 in fluid communication with the plenum 18, and a fan 24 and a make up air system 28. The makeup air is distributed via diffuser 29. The space within the hood 16 upstream of the filter 20 is sometimes referred to as the recess or canopy region 21 of the hood; and the region downstream of the filter is sometimes considered a part of the exhaust plenum 18. The fan 24 pulls kitchen air and the effluents 12 into the hood 16, through the filter 20 and into the exhaust plenum 18, then through the duct 22 and out to the atmosphere. In this example, the duct 22 is disposed completely within the ceiling 23. The flow rate at which the air is pulled from the kitchen and through the exhaust system 14 is known as the exhaust rate. This set-up is disclosed in Design Guide 2—Optimizing Makeup Air—Updated Mar. 15, 2004 (©2002 California Energy Commission).

It is important that the exhaust rate be the minimum required to capture and contain the effluents. As can be imagined, all air pumped out of the kitchen must be replaced with fresh air, known as makeup air. If the exhaust rate is higher than necessary, an excess amount of exhaust air is taken out of the kitchen and an equal amount of makeup air must be pumped back into the kitchen. Unnecessarily high hood exhaust flow rates increase energy consumption as well as negatively affect the working environment of the kitchen by creating additional noise, and air turbulence as well as exhausting expensive conditioned air from the kitchen. A high flow rate of makeup air may disturb the path of the effluents from the cooking surface into the hood, thus lowering the effectiveness of the exhaust system. The makeup air may also require conditioning, either cooling or heating, so that the kitchen staff can be comfortable in their work environment. It is another unnecessary expense to condition the unneeded makeup air. If the makeup air flow rate is less than the exhaust rate, the kitchen will become negatively pressurized, again negatively affecting the exhaust system's effectiveness. On the other hand, if the exhaust rate becomes too low for any reason, the exhaust system will not pull all the effluents into the plenum.

The required exhaust rate depends on numerous factors. This includes the type and use of the cooking equipment under the hood, the style and geometry of the hood itself, and how the makeup air is introduced into the kitchen. Certain cooking appliances create different levels of grease and smoke, have different thermal plumes, and may have inconsistent surges of thermal plumes. Of course, larger levels of grease and smoke and stronger thermal plumes require a larger exhaust rate. Moreover, wall-mounted canopy hoods (such as shown in FIG. 1) and island canopy hoods have different capture areas and are mounted at different heights and require different exhaust rates. The location of the makeup air distribution point, open widows and doors also can disrupt the thermal plume and hinder capture and containment.

Over the life of the exhaust system, the required exhaust rate may change. For example, the cooking appliances could be replaced with new cooking appliances that have different requirements. Windows may be kept open during summer to allow breezes to enter the kitchen (thereby disrupting the thermal plume), but closed during winter. Moreover, the performance of the exhaust fan may deteriorate over time, thereby lowering the exhaust rate to below optimum performance.

In another set-up disclosed in FIG. 2, a first kitchen hood 26, a second kitchen hood 28, and a third kitchen hood 30 are all connected to and in fluid communication with a common exhaust duct 32. Due to configuration of the exhaust system, the exhaust air flowing through the first hood 26 will encounter the highest resistance to air flow, while the flow of the exhaust through the third hood 30 will experience the lowest resistance to air flow. If the exhaust fan is set to provide the first hood 26 with the proper exhaust rate, then the exhaust rate of the third hood 30 may be too high. Accordingly, the owner of the building will be required to pump a high and equal amount of makeup air back into the kitchen, thereby increasing the costs as outlined above and potentially disturbing the working environment or effectiveness of the KVS. If the exhaust fan is set to provide the third hood 30 with the proper exhaust rate, then the exhaust rate of the first hood 26 may be too low. Again, where the exhaust rate is too low, the hood will not capture and contain the thermal plume as noted above.

In another set-up disclosed in FIG. 2, a first kitchen hood 26, a second kitchen hood 28, and a third kitchen hood 30 are all connected to and in fluid communication with a common exhaust duct 32, it may be beneficial to have different exhaust rates through each hood as each hood could be installed over varying cooking equipment that generate varying degrees of temperature an effluent plume.

There is a need to be able to accurately control the exhaust rate and adjust the amount of air that is being pulled out of the kitchen through each exhaust hood to accurately achieve the minimum exhaust rate continuously over the life of the exhaust system. This need is particularly acute in systems with multiple kitchen hoods connected to a common exhaust duct as disclosed in FIG. 2.

Previously known duct dampers have been designed to allow for the adjustment of damper devices. However, mechanisms for adjusting and locking the damper devices in place have generally been located on the outside of the damper apparatus. This external adjustment adds complications when the damper or its adjustment mechanisms are not easily accessible by their operators. For example, a large percentage of kitchen ventilation hoods are installed in close proximity to ceilings or walls, such as shown in FIG. 1 and as a result, the ducts exiting the hood may immediately pass through ceilings or walls or have obstructions that make accessing the outside of the damper apparatus to make adjustments, lock or unlock, difficult or impossible. In this manner, ceilings walls or obstructions may prevent the making of adjustments to position the apparatus, such as dampers, disposed in the most desired position which is in close proximity to the hood.

There is therefore a need for a damper device that may be used with exhaust hoods that do not suffer from the above-described shortcomings.

### BRIEF SUMMARY

The present invention provides an internally adjustable damper for use in a commercial kitchen hood. The hood includes: a housing having a sidewall defining an interior, the housing further including a first open end and a second open end in fluid communication with the first open end; a damper blade disposed within the housing and rotatable about an axis of rotation to allow a selectable resistance to air flow; a first arch extending from the damper blade and adjacent to the sidewall, the first arch being symmetric about the axis of rotation; a threaded stud extending from the sidewall into the interior and disposed adjacent the first arch; and a fastener operatively coupled to the threaded stud, wherein the fastener is adapted to selectively press down against the first arch, thereby fixing the location of the damper blade, and retract from the first arch, thereby allowing the damper blade to rotate about the axis of rotation; wherein the fastener and the damper blade are accessible inside the housing through either the first open end or the second open end.

In another aspect, the present invention provides a method of adjusting the resistance to air flow of a commercial kitchen hood. The method includes removing a first filter from a first hood to expose an interior of a first plenum in the first hood and an inside of a first housing operatively coupled to the first plenum, the first housing having an open first end in fluid communication with the first plenum and an open second end in fluid communication with the first end; loosening a fastener disposed within the first housing to release a first damper blade disposed within the first housing, the fastener and the first damper blade being accessible through the first plenum and the open first end; and rotating the first damper blade about an axis of rotation to adjust a first exhaust rate.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 is a simplified side view of a kitchen appliance and a prior art kitchen exhaust system with a single kitchen appliance and hood.

FIG. 2 is a perspective view of a prior art kitchen exhaust system with multiple hoods and a common exhaust duct.

FIG. 3 is a perspective view of a kitchen exhaust system with multiple hoods, where each hood has an internally adjustable damper device and an electronic component enclosure associated with it, and a common exhaust duct, in accordance with the embodiments of the present invention.

FIG. 4 is a bottom perspective view of a hood, damper device, and enclosure as disclosed in FIG. 3.

FIG. 5 is a top perspective view of the enclosure and damper device of FIG. 4.

FIG. 6 is an exploded view of the damper device and enclosure of FIG. 5.

FIG. 7 is an enlarged bottom perspective view of the damper device of FIG. 5.

FIG. 8 is an exploded view of a damper blade used in the damper device of FIG. 5.

FIG. 9 is a section view of the damper device taken along line A-A in FIG. 5, where the damper blades are in the fully closed position.

FIG. 10 is a section view of the damper device taken along line A-A in FIG. 5, where the damper blades are in the fully open position.

FIGS. 11a-11g are a series of cross sectional views depicting alternative designs of the panels of the housing of the damper device.

FIG. 12 is a front section view of the electronic component enclosure taken along line B-B in FIG. 5.

FIG. 13 is an isometric cutaway view of the enclosure and the removable cover.

FIGS. 14a and 14b are cross sectional views depicting alternative designs of the side panels of the enclosure.

FIG. 15 is a perspective view of an alternate embodiment of the enclosure.

FIG. 16 is a perspective view of an alternate embodiment, where the damper device has multiple electronic enclosures associated with it.

### DETAILED DESCRIPTION OF THE INVENTION

FIG. 3 shows pertinent details of a kitchen hood exhaust system 34 that addresses the foregoing issues. The kitchen exhaust system 34 includes a first hood 36 with a first variable volume damper device 38 and a first electronic component enclosure 40 mounted to the first hood 36. It further includes a second hood 42 with a second damper device 44 and second enclosure 46 mounted to the second hood 42, and a third hood 48 with a third damper device 50 and a third enclosure 52 mounted to the third hood 48.

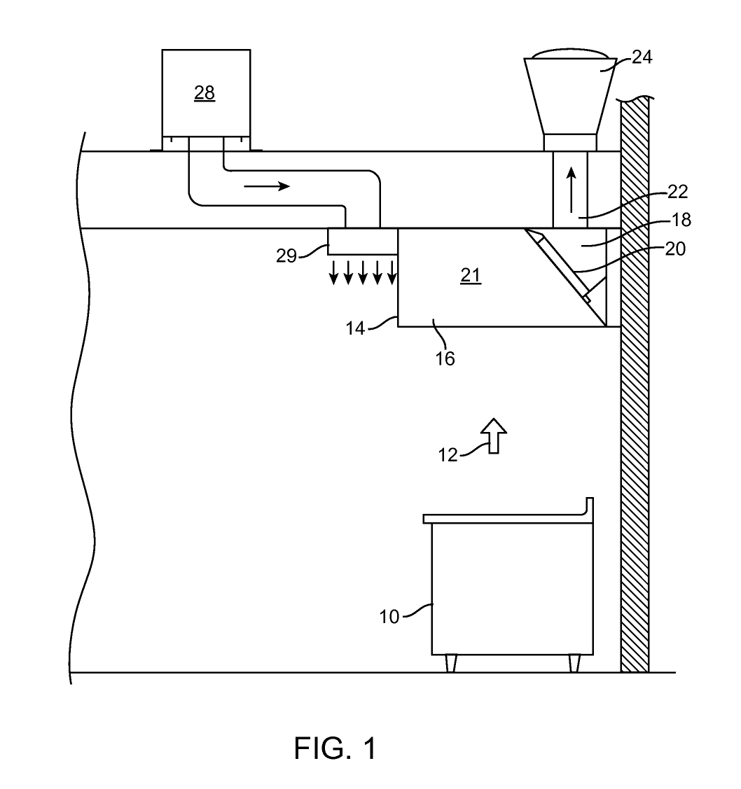

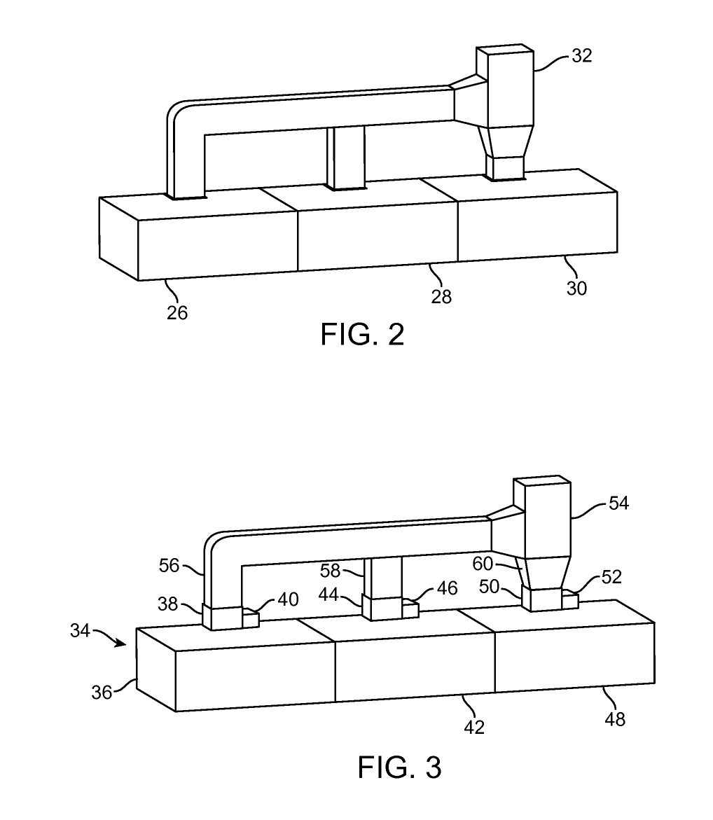

Each damper device 38, 44, 50 is disposed between its respective kitchen hood 36, 42, 48 and a common exhaust duct 54. Each of the first damper device 38, second damper device 44, and third damper device 50 are connected to a first exhaust duct 56, a second exhaust duct 58, and a third exhaust duct 60, respectively. Each of the first exhaust duct 56, the second exhaust duct 58, and the third exhaust duct 60 are connected to the common exhaust duct 54. A single exhaust fan, such as shown in FIG. 1, pulls all exhaust from the first, second and third hoods 36, 42, 48 through the common exhaust duct 54. Each damper device 38, 44, 50 allows for independent adjustment of its air flow resistance, and thus the exhaust flow through its respective kitchen hood 36, 42, 48 such that each kitchen hood 36, 42, 48 can be set to have an equal, un-equal and/or proper exhaust rate.

Each electronic component enclosure 40, 46, 52 allows a probe to be positioned in its associated damper device 38, 44, 50 or kitchen hood 36, 42, 48 to monitor, for example, temperature. For brevity, each internally adjustable damper device 38, 44, 50 is alternately referred to herein as simply a damper device. Moreover, the electronic component enclosure 40, 46, 52 is alternately referred to as simply an enclosure.

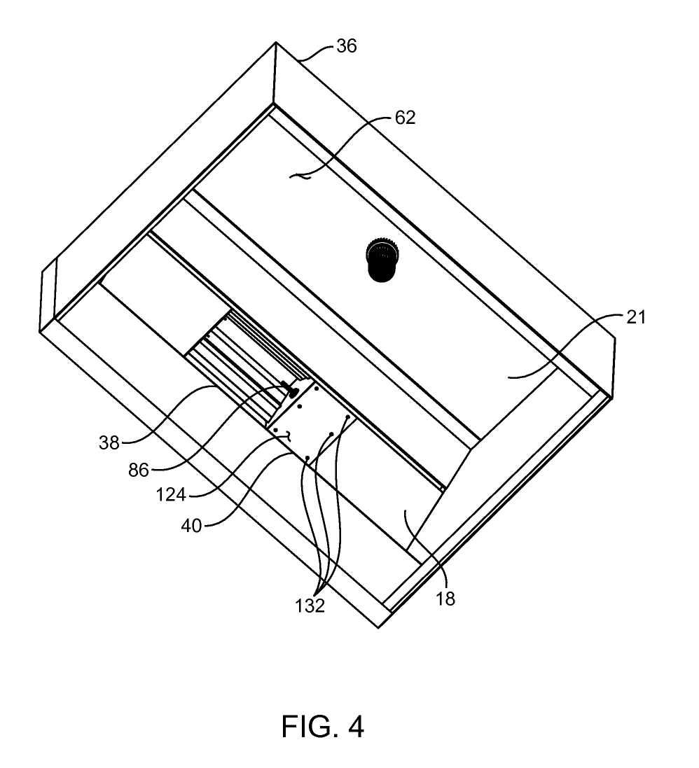

FIG. 4 shows a perspective view as viewed from underneath of the first hood 36, the first damper device 38, and the first enclosure 40. Typically, air filters are installed in-the hood 36 (as shown in FIG. 1), but in this view the filters has been removed to allow for visualization of inside an exhaust plenum 18 of the hood 36, thus revealing the first damper device 38 and the first enclosure 40. As will be readily understood, only the first damper device 38 and first enclosure 40 will be described herein, but both the second and third damper devices 44, 50 can be the same as the first damper device 40, and both the second and third enclosures 46, 52 can be the same as the first enclosure 40.

As shown in FIGS. 3 and 4, the damper device 38 is operatively coupled to the hood 36, is installed adjacent the hood 36, and can be installed between the hood 36 and the first exhaust duct 56. The damper device 38 is located above and in fluid communication with the hood 36. On the other hand, the damper device 38 could be installed within the hood 36 itself. Moreover, it can be seen that upon removing the filter from the hood 36, both the damper device 38 and the enclosure 40 are visible and accessible by reaching inside the exhaust plenum 18.

Referring now to FIG. 5, an enlarged isometric view of the damper device 38 and enclosure 40 are shown without the kitchen hood. The damper device 38 includes a housing 64 having a sidewall 66 defining an interior 68, the sidewall 66 including a left end panel 70, a right end panel 72, a front panel 74, and a rear panel 76. The housing 64 also defines a first open end 78 and a second open end 80, where the second open end 80 is in fluid communication with the first open end 78. Although the disclosed housing 64 is depicted as having four generally rectangular flat panels 70, 72, 74, 76, other sidewall configurations such as a cylinder are also contemplated. As will be described more fully herein, disposed within the housing 64 is a pair of rotatable, generally rectangular damper blades 82, 84 that extend from the left end panel 70 to the right end panel 72. The damper blades 82, 84 are rotatable to allow a user to vary the resistance that the exhaust fan has to overcome thereby varying the volume of air being exhausted through the damper relative to the capabilities of the exhaust fan and the other demands of the exhaust system.

The enclosure 40 can house electronic components adjacent the exhaust plenum 18 and is accessible through the exhaust plenum 18 once the filter is removed. Moreover, the components stored inside the enclosure 40 are accessible from inside the exhaust plenum 18. While the enclosure 40 is adjacent to and accessible from inside the exhaust plenum 18, the enclosure 40 protects the components from the airborne grease and other effluents that are pulled into the exhaust plenum 18 and removed from the kitchen by the exhaust system 34. As will be described more fully herein, in this embodiment a probe 86 such as a temperature probe extends from inside the enclosure 40 and into the housing 64.

The enclosure 40 houses all necessary electronic components to facilitate the temperature probe 86 and allows the components to be connected to a computer or other component. In one embodiment, the computer is also connected to a controller of the exhaust fan, such that as the temperature probe reads a higher temperature, the computer can direct the exhaust fan to run faster. As will be seen, the configuration of the plenum 62 and enclosure 40 allows for a user to have easy access to the electronic components stored inside the enclosure 40.

Referring now to FIGS. 5-10, the dampening device 38 having two dampening blades 82, 84 are disclosed. Although the disclosed device includes two dampening blades, only the first dampening blade 82 will be described herein. It is understood that that second dampening blade 84 can have the same construction as the first dampening blade 82 and can be a mirror image to the first blade 82. The second dampening blade 84 can be independently movable from the first dampening blade 82, although it is envisioned that the second dampening blade 84 can also be interconnected to the first dampening blade 82 through, for example, gearing and/or belts such that movement of one blade will move the other. Moreover, although two dampening blades 82, 84 are described, the system could function with a single dampening blade 82 or three or more dampening blades.

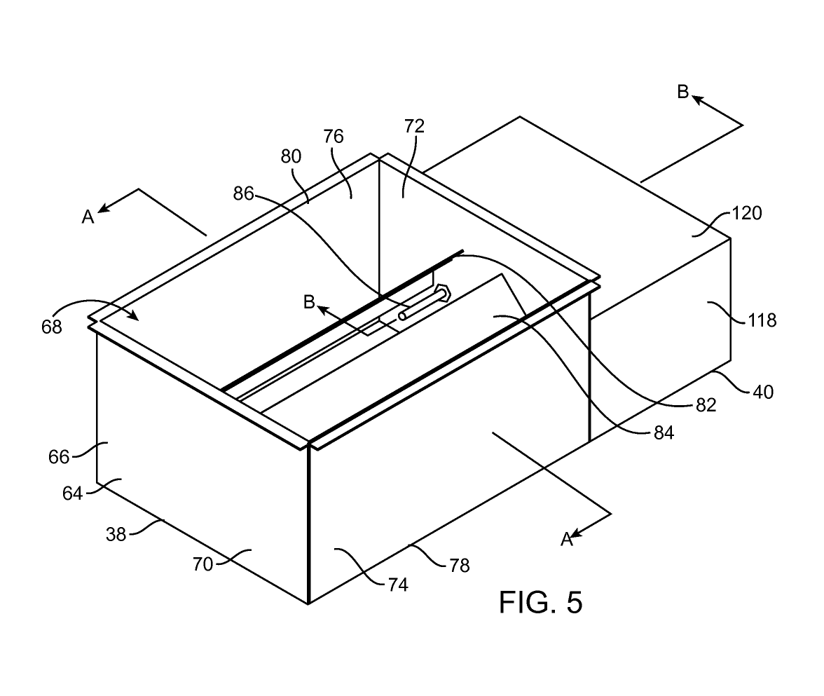

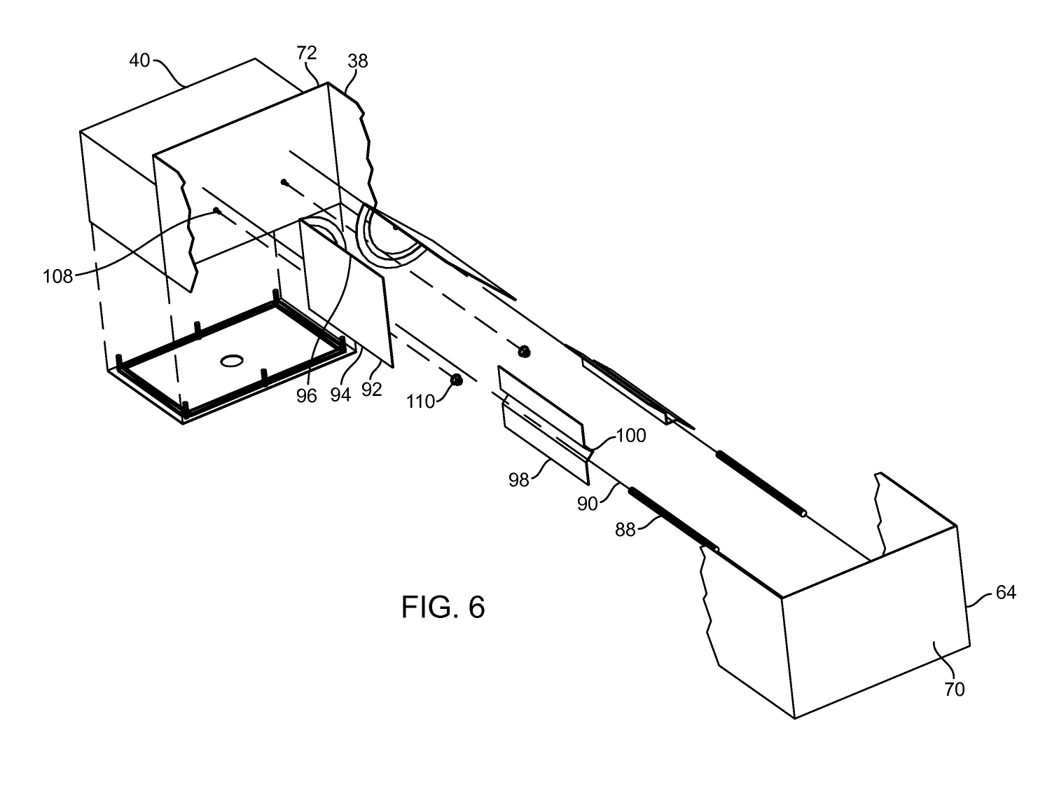

Referring now to the first dampening blade 82 and in particular to FIGS. 6 and 8, a rod 88 extends from the left end panel 70 to the right end panel 72 and is connected on its ends to the end panels 70, 72. In one example, the rod 88 is welded to the housing 64. The rod 88 defines an axis of rotation 90 about which the first damper blade 82 rotates. The damper blade 82 includes a generally rectangular baffle 92 having a leading edge 94 and a trailing edge 96. The damper blade 82 further includes a sandwich panel 98 connected to the baffle 92. The sandwich panel 98 can be welded to the baffle 92. The sandwich panel 98 includes a triangular recess 100 extending along its length. The rod 88 is disposed within the recess 100 between the sandwich panel 98 and the baffle 92 in a relatively tight fit. The rod 88 simultaneously supports the damper blade 82 and allows the damper blade 82 to rotate about the rod 88 and the axis of rotation 90. Other configurations to support and allow a damper blade to rotate within the housing can be used.

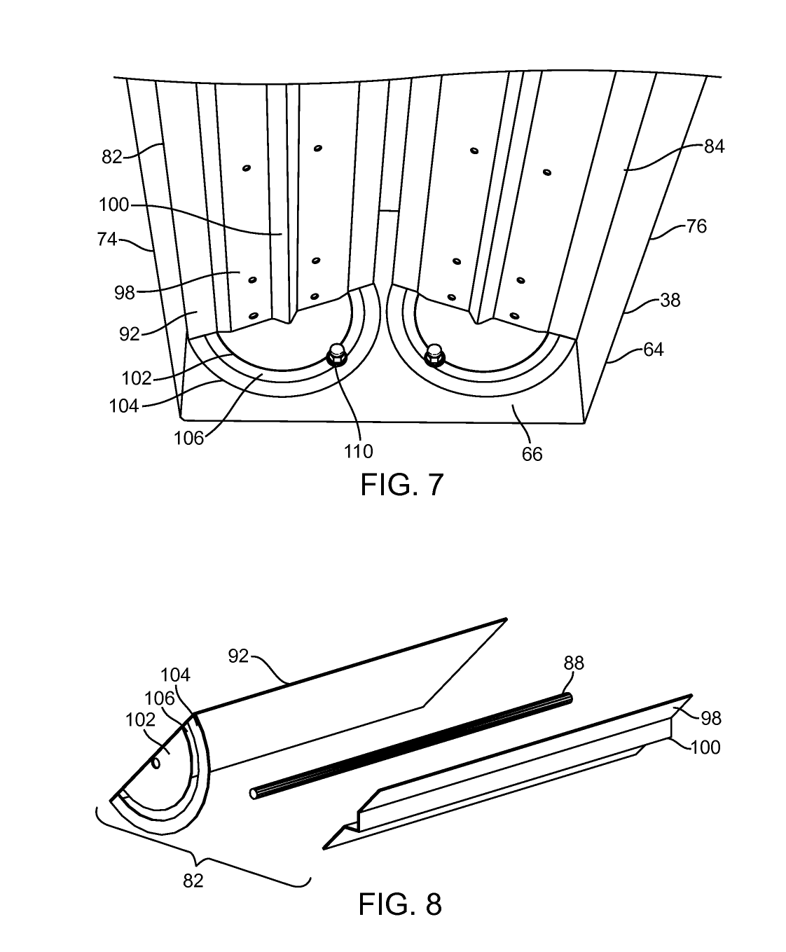

Extending generally perpendicular from an end of the baffle 92 is a semicircular panel 102 and a semicircular arch 104, which can best be seen in FIGS. 7 and 8. Both the panel 102 and the arch 104 are generally adjacent to and parallel to the sidewall 66 of the housing 64 and are symmetric about the axis of rotation 90. A semicircular gap 106 is defined between the panel 102 and the arch 104. In this example, the baffle 92, panel 102, and arch 104 are made from a single piece of sheet metal that is stamped to form the baffle 92, panel 102, arch 104, and gap 106 in a single sheet, where that sheet is then bent such that the panel 102 and arch 104 are perpendicular to the baffle 92. The naming convention of the semicircular panel 102 and semicircular arch 104 is for ease of reference, and no limitation should be read therein. For example, the panel 102 can also be considered an arch.

A threaded stud 108 extends inwardly from the sidewall 66 into the interior 68 of the housing 64. The stud 108 is disposed within the semicircular gap 106, adjacent both the semicircular panel 102 and the semicircular arch 104. A fastener 110 such as a locking bolt is screwed onto the threaded stud 108. While the disclosed fastener 110 may require a wrench, other known fasteners such as wing nuts may also be used that do not require a tool. When fully screwed down, the fastener 110 presses against the panel 102, the arch 104, and the sidewall 66, thereby securing the damper blade 82 in its location by friction against the sidewall 66, seen best in FIGS. 7, 9, and 10

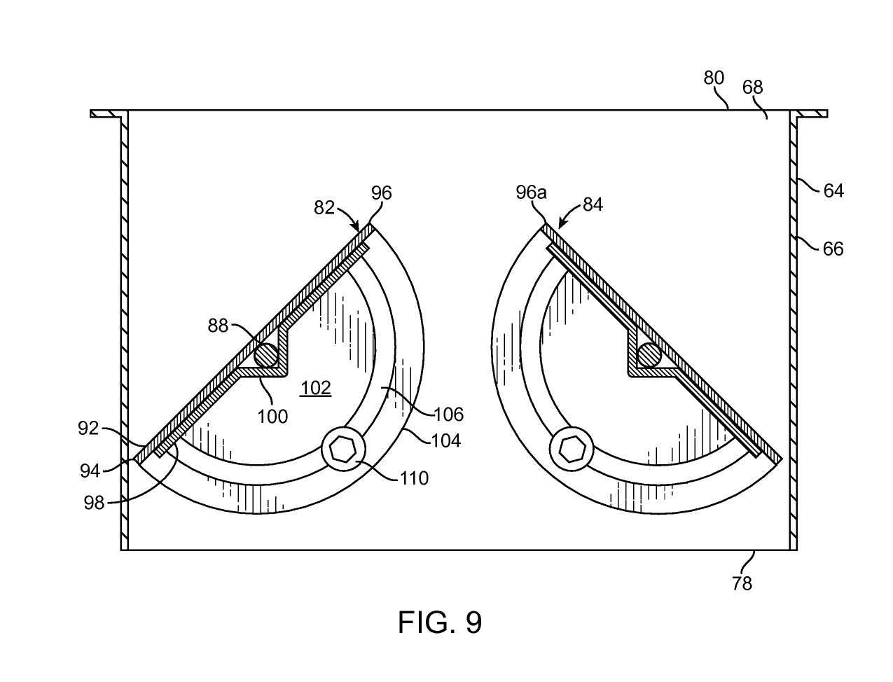

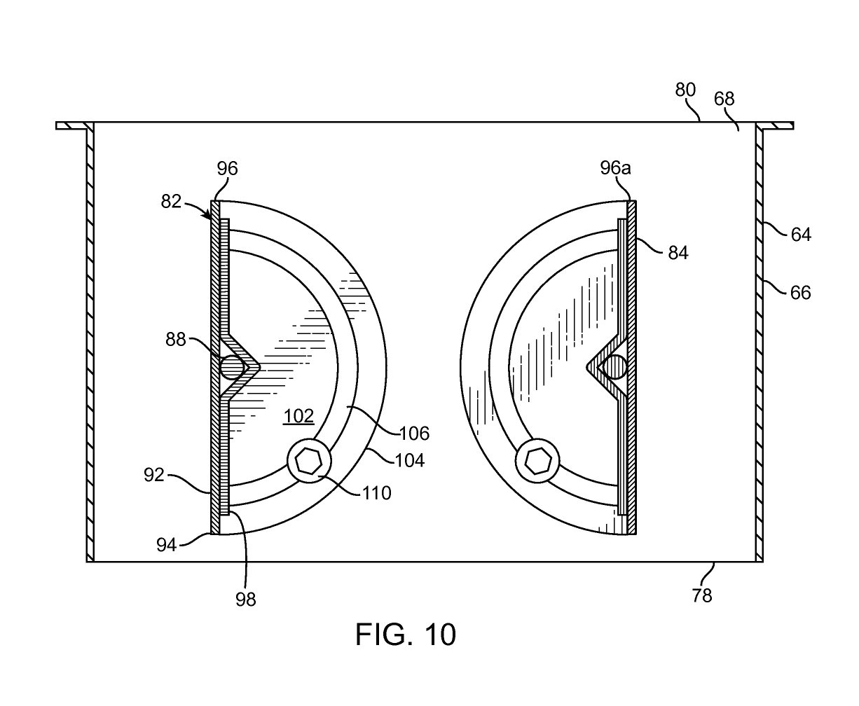

To adjust the air flow resistance of the damper device, a user can remove the filter 20 from the exhaust plenum 18 to gain access to the damper device 38. He or she can reach inside the exhaust plenum 18, into the housing 64, and unscrew the fastener 110 to release the damper blade 82. The user can then rotate the damper blade 82 manually to increase or decrease the resistance to air flow created by the exhaust fan. The user can then refasten the fastener 110 to fix the damper blade 82 in the desired orientation. As shown in FIG. 10, the damper blades 82, 84 can be rotated to a fully open position where the blades are parallel to the direction of air flow. As shown in FIG. 9, the damper blades 82, 84 can also be rotated to a fully closed position. However, in the fully closed position, the damper blades 82, 84 maintain a gap between them at their trailing edges 96, 96a, for example, it is 5% open relative to the first open end or the second open end (95% fully closed), to allow a small amount of exhaust to pass through. Based on this construction, it is possible to adjust the resistance of the damper device and hence the exhaust rate by reaching inside the hood 36 and housing 64. Accordingly, the problem of prior art devices having their adjustment hardware on the outside of the housing 64 is solved by this configuration. Moreover, in setups as shown in FIG. 3, the problem of multiple kitchen hoods connected to a common exhaust duct is also solved. The user can independently adjust the exhaust rates of each kitchen hood such that the exhaust rates of each hood is substantially equal or unequal whichever best meets the demands of the cooking equipment being exhausted under each hood.

In other examples not shown, labels can be disposed adjacent the arch that identify the resistance value or exhaust rate for various rotational orientations of the damper blades 82, 84. In other words, the label will identify the air flow resistance or exhaust rate that will be achieved when the damper blades 82, 84 are placed in a particular angular orientation. Moreover, means known in the art can be employed to allow setting of discrete, predetermined angular locations corresponding to various exhaust rates.

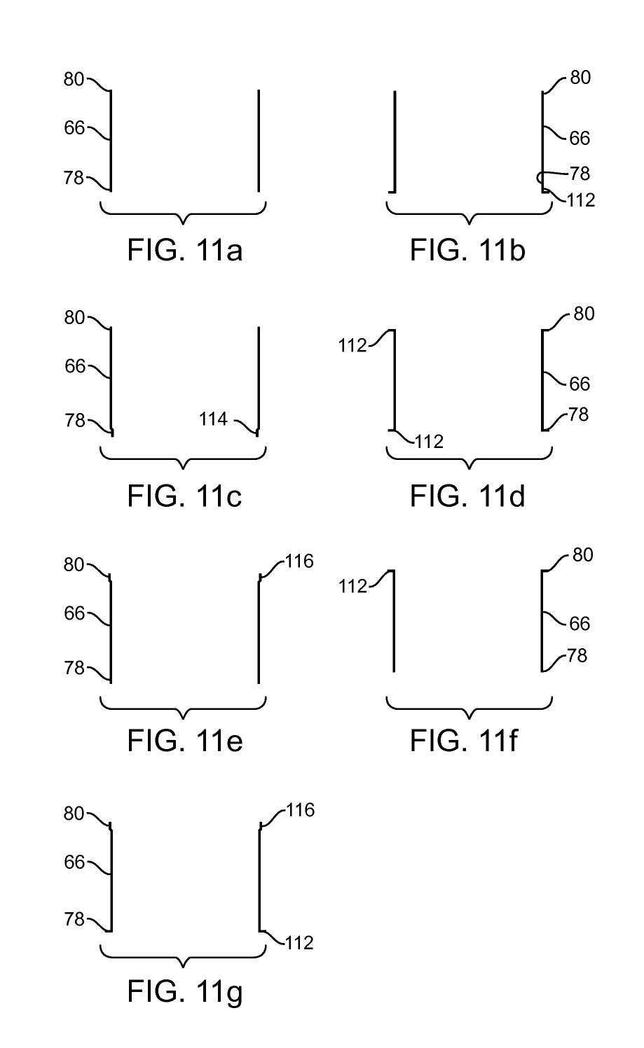

Referring generally now to FIGS. 11a-11g, the sidewall 66 of the housing 64 can have a number of different cross sections that allow for different types of duct and hood connections in the field. FIG. 11a depicts that the sidewall 66 is simply straight at the first open end 78 and the second open end 80. FIG. 11b depicts that the sidewall 66 includes a flange 112 extending perpendicularly outward at the first open end 78. In FIG. 11c, the sidewall 66 includes an inset ridge 114 at the first open end 78. In FIG. 11d, the sidewall includes flanges 112 extending perpendicularly outward at both the first open end 78 and the second open end 80. In FIG. 11e, the sidewall 66 includes an outset ridge 116 at the second open end 80. In FIG. 11f, the sidewall 66 includes a flange 112 extending perpendicularly outward at the second open end 80 this is the configuration shown in FIG. 5. Finally, in FIG. 11g, the sidewall includes a flange 112 extending perpendicularly outward at the first open end 78 and an outset ridge 116 at the second open end 80.

Referring now to FIGS. 4, 5, 12 and 13, the electronic component enclosure 40 is shown. The enclosure 40 is operatively coupled to the hood 36. The enclosure 40 should be so situated relative to the hood 36 such that the probe 86 can extend out of the enclosure 40 and into the air flow captured by the hood 36. Moreover, the enclosure 40 should be accessible from inside the hood 36. In this embodiment, the enclosure 40 is disposed above the hood 36 and is mounted to the hood 36. As mentioned earlier, the enclosure 40 safely houses electronic components away from the harsh high temperature grease laden unclean environment of the plenum 62, yet allows easy access to the components from inside the hood 36.

The enclosure 40 is essentially a container 117 with four side panels 118, a top panel 120, and an open bottom 122 with a removable cover 124 that is secured over the open bottom 122. The enclosure 40 defines an interior 125. When the cover 124 is attached to the container 117, the interior 125 is sealed from the exhaust plenum 18. When the cover 124 is detached from the container 117, the interior 125 is exposed to the exhaust plenum 18. The enclosure 40 can be placed adjacent to the damper device 38, where a side panel 118a of the enclosure 40 butts up against the sidewall 66 of the housing 64 of the damper device 38.

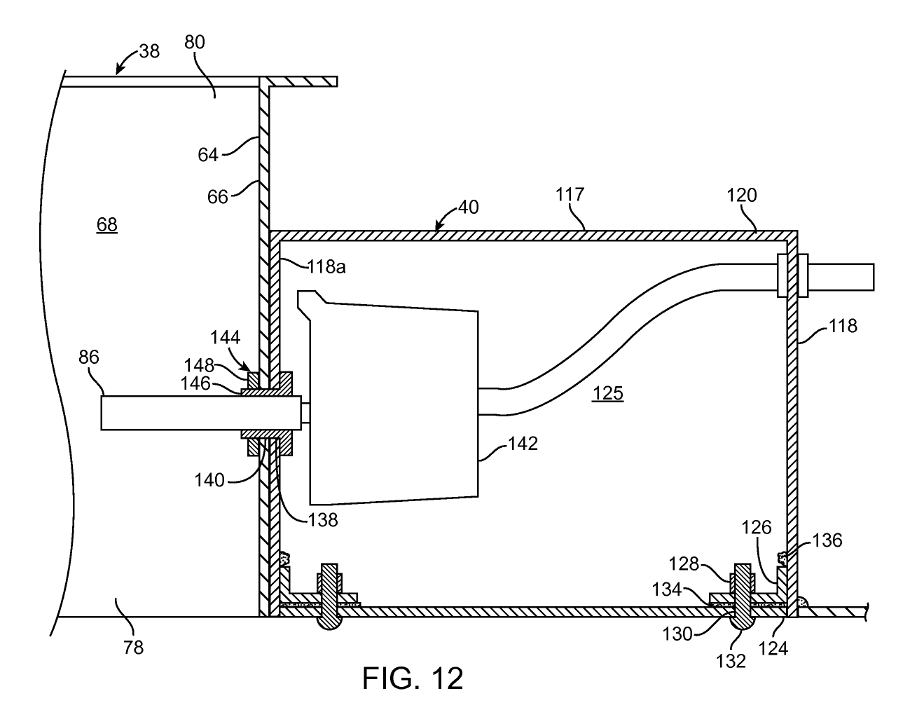

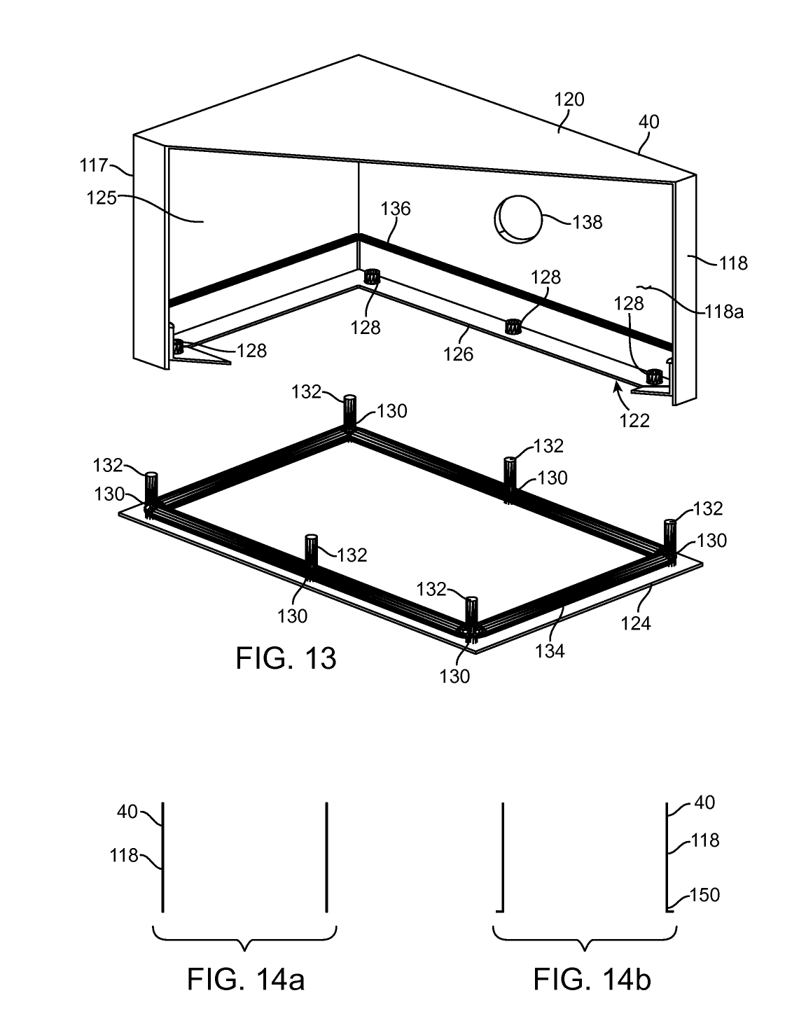

Referring particularly to FIGS. 12 and 13, an L-shaped flange 126 is welded to the side panels 118 adjacent the open bottom 122 and extends inwardly along the perimeter of the open bottom 122. The L-shaped flange 126 includes internally threaded slugs 128 extending upwardly. The removable cover 124 includes through holes 130 coincident with the slugs 128 such that the cover 124 can be fastened to the housing 64 with screws 132 through the through holes 130 into the slugs 128. A gasket 134 is disposed around the perimeter of the removable cover 124, such that when the cover 124 is fastened to the housing 64, the gasket 134 presses against the L-shaped flange 126 to seal the enclosure 40 tightly.

The enclosure 40 includes a continuous fire stop 136 disposed about its side panels 118. The fire stop 136 is a high temperature paste disposed in a gap between the L-shaped flange 126 and the enclosure panels 118. In this example, the L-shaped flange 126 is spot-welded to the enclosure panels 118. Thus, there are gaps between the spot welds and between the flange 126 and the panels 118. The fire stop 136 fills up the gaps and prevents fire and smoke from penetrating into the enclosure 40 between the side panels 118 and the L-shaped flange 126.

In this example, the enclosure 40 includes an access port 138 in its first side panel 118a. Likewise, the housing 64 of the damper device 38 includes a coincident access port 140 in its side wall 66. An electronic element such as the temperature probe 86 can be disposed within the enclosure 40, extend through the access port 138 in the first side panel 118a in the enclosure 40, the access port 140 in the sidewall 66 of the housing 64, and into the interior 68 of the housing 64. An electronic component 142 such as a controller is mounted within the enclosure 40 and connected to the probe 86.

The access port 138, 140 in the enclosure 40 and housing 38 can be sealed with a quick seal 144 such as one manufactured by Evergreen Tool Co., Model #171 or 899. The quick seal 144 includes an externally threaded nipple 146 and a locking nut 148. Moreover, the nipple 146 can also be internally threaded, with the temperature probe 86 being externally threaded and screwed into the pipe nipple 146. In this manner, the temperature probe 86 can extend into the housing 64 and pass data to the controller 142 without compromising the integrity of the enclosure 40 or subjecting the controller 142 to the harsh high-temperature grease-laden unclean exhaust. Also shown is a conduit extending from controller 142 to allow for the control signal from the controller 142 to be used by other systems that receive the signal, for example, the fan control logic.

If the controller 142 or temperature probe 86 need to be replaced or updated, a user can again simply remove the filter to open the exhaust plenum 18 and gain access to the enclosure 40. As can be seen in FIG. 4, the screws 132 are easily accessible from within the exhaust plenum 18. After removing the screws 132, the removable cover 124 can be removed, and, if necessary, the temperature probe 86 can be screwed out of the quick seal 144. The probe 86 and controller 142 can then be addressed. Once the necessary actions have been taken, the probe 86, controller 142, and quick seal 144 can be reinstalled, the removable cover 124 can be fixed to the enclosure 40, and the filter can be reinstalled.

Referring generally now to FIGS. 14a and 14b, the side panels 118 of the enclosure 40 have a number of different cross sections that allow for different types of connections to the removable cover. FIG. 14a depicts that the side panels 118 are simply straight. FIG. 14b depicts that the side panels 118 include a flange 150 extending outwardly.

FIG. 15 shows a second embodiment of the enclosure 152. Here, the access port is not in the side panel of the enclosure as is shown in FIG. 12. Instead, the access port 154 is disposed within the removable panel 156 itself. Thus, in this example, the temperature probe 86 would extend downwardly into the exhaust plenum 18 of the hood 36 instead of extending into the housing 64 of the damper device 38.

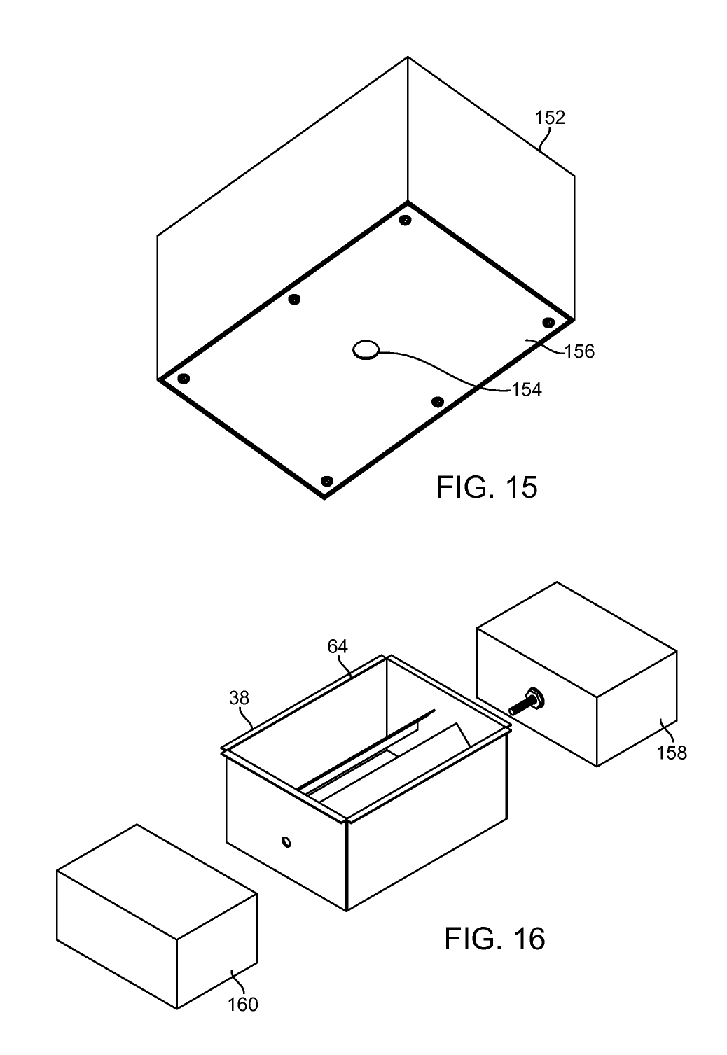

FIG. 16 shows another embodiment where a first enclosure 158 and a second enclosure 160 are both associated with the damper device 38. In this example, a first temperature probe 86 can extend into the housing 64 from the first enclosure 158, while a second temperature probe 86 can extend into the housing 64 from the second enclosure 160. In another example similar to the example shown in FIG. 16, two enclosures are associated with a single damper device, with a first temperature probe extending into the housing from the first enclosure, and a second temperature probe extending into the exhaust plenum 18 from the second enclosure as shown in FIG. 15.

Other uses of the electrical component enclosure can be envisioned. For example, the probe 86 can be a flow meter that can measure the actual exhaust rate, or could be a pitot tube used to measure fluid flow velocity. Over time, the performance of the exhaust fan may deteriorate, thereby lowering the exhaust rate. A flow meter can be used to ensure that the exhaust rate stays at the optimum level or the pitot tube could be used to measure pressure variations. If the exhaust rate dips, the user can simply rotate the damper blades to a position that allows more air to flow. In another example, the damper blades are connected to a small electric motor, through known elements such as belts and/or gears, where a controller is electrically connected to both the temperature sensor, the flow meter and the electric motor. The controller can read the exhaust rate based on the reading of the flow meter and adjust the angular position of the damper blades to ensure that the exhaust rate stays at the optimum level. Similarly, the controller can read the fluid flow velocity using a pitot tube as described herein, and rotate the damper blades according to the exhaust requirements based on the pressure variation. Similarly, the controller can read the temperature of the exhaust using a temperature probe as described herein, and rotate the damper blades according to any exhaust needs required by a temperature increase. For example, if the temperature increases, it may be necessary to increase the exhaust rate.

As will be understood by those skilled in the art, the present invention may be embodied in other specific forms without departing from the essential characteristics thereof. Many other embodiments are possible without deviating from the spirit and scope of the invention. These other embodiments are intended to be included within the scope of the present invention, which is set forth in the following claims.

What is claimed is:

1. An internally adjustable damper for use in a commercial kitchen hood, comprising:
a housing having a sidewall defining an interior, the housing further including a first open end and a second open end in fluid communication with the first open end;
a damper blade disposed within the housing and rotatable about an axis of rotation to allow a selectable resistance to air flow;
a first arch extending from the damper blade and adjacent to the sidewall, the first arch being symmetric about the axis of rotation;
a threaded stud extending from the sidewall into the interior and disposed adjacent the first arch; and
a fastener operatively coupled to the threaded stud, wherein the fastener is adapted to selectively press down against the first arch, thereby fixing the location of the damper blade, and retract from the first arch, thereby allowing the damper blade to rotate about the axis of rotation;
wherein the fastener and the damper blade are accessible inside the housing through either the first open end or the second open end.

2. The damper of claim 1, further comprising a second arch extending from the damper blade, the second arch being symmetric about the axis of rotation, the first arch and the second arch defining a gap there between, the threaded stud being disposed in the gap.

3. The damper of claim 1, the housing having a right end and a left end, the damper further comprising a rod extending from the left end to the right end, the rod defining the axis of rotation.

4. The damper of claim 3, the damper blade further comprising a baffle and a sandwich panel, wherein the rod is disposed between the baffle and the sandwich panel.

5. The damper of claim 4, the sandwich panel including a V-shaped recess, the rod being disposed in the V-shaped recess.

6. The damper of claim 1, further comprising a second damper blade disposed within the housing and rotatable about a second axis of rotation.

7. The damper of claim 6, wherein the damper blade and the second damper blade are rotatable between a 100% open position and a 95% closed position relative to the first open end or the second open end.

8. The damper of claim 6, wherein the damper blade is independently rotatable from the second damper blade.

9. The damper of claim 6, wherein the damper blade is interconnected to the second damper blade.

10. The damper of claim 1, wherein the housing includes a set of flanges on the second open end sized and shaped to allow the housing to be connected to an exhaust duct.

11. An exhaust system for a commercial kitchen, the exhaust system comprising:
a first hood having a first plenum, the first hood being sized and shaped to receive a first filter, wherein upon removal of the first filter an interior of the first plenum is accessible;
a first housing having a first open end in fluid communication with the plenum and an opposing second open end in fluid communication with the first open end; and
a first damper blade disposed within the first housing and rotatable about a first axis of rotation, the first damper blade being securable in a selected rotational orientation to allow the setting of a first resistance to air flow;
wherein when the first filter is removed from the first plenum, the first damper blade is accessible through the first plenum to allow selectable rotation and securement of the first damper blade.

12. The exhaust system of claim 11, further comprising:
a second hood having a second plenum;
a second housing in fluid communication with the second plenum;
a second damper blade disposed within the second housing and rotatable about a second axis of rotation, the second damper blade being securable in a selected rotational orientation to allow the setting of a second resistance to air flow; and
an exhaust duct in fluid communication with the first housing and the second housing;
wherein the first damper blade and the second damper blade are independently rotatable such that the first resistance to airflow can be set to be equal or unequal as the second resistance to air flow by independent rotation of the first damper blade and second damper blade.

13. The exhaust system of claim 11, further comprising a second damper blade rotatably disposed within the first housing.

14. The exhaust system of claim 11, further comprising an enclosure adjacent the first housing, an electric motor being disposed in the enclosure, the electric motor being adapted to rotate the first damper blade.

15. The exhaust system of claim 14, further comprising a flow meter, wherein the electric motor is adapted to rotate the first damper blade in response to an indication from the flow meter.

16. The exhaust system of claim 15, further comprising a temperature sensor, wherein the electric motor is adapted to rotate the first damper blade in response to an indication from the temperature sensor.

17. A method of adjusting the air flow resistance of a commercial kitchen hood, the method comprising:
removing a first filter from a first hood to expose an interior of a first plenum in the first hood and an inside of a first housing operatively coupled to the first plenum, the first housing having an open first end in fluid communication with the first plenum and an open second end in fluid communication with the first end;
loosening a fastener disposed within the first housing to release a first damper blade disposed within the first housing, the fastener and the first damper blade being accessible through the first plenum and the open first end; and
rotating the first damper blade about an axis of rotation to adjust a first air flow resistance.

18. The method of claim 17, further comprising:
removing a second filter from a second hood to expose an interior of a second plenum in the second hood and an inside of a second housing operatively coupled to the second plenum, the second housing having an open first end in fluid communication with the second plenum and an open second end in fluid communication with the open first end, wherein the first housing and second housing are in fluid communication with a common exhaust duct; and
rotating a second damper blade disposed within the second housing about an axis of rotation to adjust a second air flow resistance.

19. The method of claim 17, the rotating step further comprising rotating the first damper blade about a rod, wherein the rod extends across the first housing, the first damper blade including a baffle and a sandwich panel, the rod being disposed between the baffle and the sandwich panel.

20. The method of claim 17, further comprising rotating a second damper blade about a second axis of rotation, the second damper blade being disposed within the first housing and accessible through the first plenum and the first end.

21. The method of claim 19 further comprising rotating the first damper blade independently of the second damper blade.
